(19) United States
(12) Patent Application Publication
(10) Pub. No.: US 2021/0264040 A1
(43) Pub. Date: Aug. 26, 2021

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventor: Naomi HIRAOKA, Kanagawa (JP)

(73) Assignee: FUJI XEROX CO., LTD., Tokyo (JP)

(21) Appl. No.: 17/061,287

(22) Filed: Oct. 1, 2020

(30) Foreign Application Priority Data
Feb. 26, 2020 (JP) 2020-030122

(51) Int. Cl. G06F 21/60; G06F 3/147; G06F 21/62

(52) U.S. Cl. CPC G06F 21/606; G06F 3/04817; G06F 21/6218; G06F 3/147

(57) ABSTRACT

An information processing apparatus includes a processor configured to: in response to a certain operation on document information representing a document file presented on a screen, transmit content of the document file to another apparatus registered in advance, with a screen smaller than that of the information processing apparatus or with no screen, based on a type of the another apparatus.

### CROSS-REFERENCE TO RELATED APPLICATIONS

This application is based on and claims priority under 35 USC 119 from Japanese Patent Application No. 2020-030122 filed Feb. 26, 2020.

### BACKGROUND

### (i) Technical Field

The present disclosure relates to an information processing apparatus and a non-transitory computer readable medium.

### (ii) Related Art

Japanese Unexamined Patent Application Publication No. 2006-227707 discloses an image processing apparatus including: an image data accumulating unit that accumulates image data; a display that displays a thumbnail of an image corresponding to the image data; an image data memory that stores thumbnail image data corresponding to the thumbnail displayed by the display; a generating unit that generates the thumbnail image data from the image data accumulated in the image data accumulating unit; a transfer unit that transfers the generated thumbnail image data to the image data memory; and a determining unit that determines whether to display or not display the thumbnail on the display. The determining unit performs control to determine whether to display or not display the thumbnail based on a security attribute of the image data.

In the case of performing a task using a personal computer (PC) in a meeting room inside a company or at a meeting place or work place outside the company, there is a demand for quickly obtaining information requested by a user from a document file. For example, when a user is working outside his/her company, if the user wants to browse a document file containing the company's confidential information on his/her PC, there is a risk of leakage of the confidential information when another person peeps into the screen.

### SUMMARY

Aspects of non-limiting embodiments of the present disclosure relate to providing an information processing apparatus and a non-transitory computer readable medium for making it possible to obtain information requested by a user from a document file and to transmit the information to another apparatus.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor. The processor is configured to: in response to a certain operation on document information representing a document file presented on a screen, transmit content of the document file to another apparatus registered in advance, with a screen smaller than the screen of the information processing apparatus or with no screen, based on a type of the another apparatus.

### BRIEF DESCRIPTION OF THE DRAWINGS

An exemplary embodiment of the present disclosure will be described in detail based on the following figure, wherein:

FIG. 1 is a diagram illustrating a schematic configuration of an information processing system according to an exemplary embodiment;

FIG. 2 is a block diagram illustrating the hardware configuration of an information processing apparatus;

FIG. 3 is a block diagram illustrating an exemplary functional configuration of the information processing apparatus;

FIG. 4 is a flowchart illustrating the flow of an information transmission process performed by the information processing apparatus;

FIG. 5 is a diagram illustrating an exemplary user interface;

FIG. 6 is a diagram illustrating an exemplary user interface;

FIG. 7 is a diagram illustrating an exemplary user interface; and

FIG. 8 is a diagram illustrating an exemplary user interface.

### DETAILED DESCRIPTION

Hereinafter, an exemplary embodiment of the present disclosure will be described with reference to the drawings. Note that the same or equivalent elements and parts in the drawings are given the same reference numeral. In addition, the dimensional ratios in the drawings are exaggerated for convenience of description, and may differ from the actual ratios.

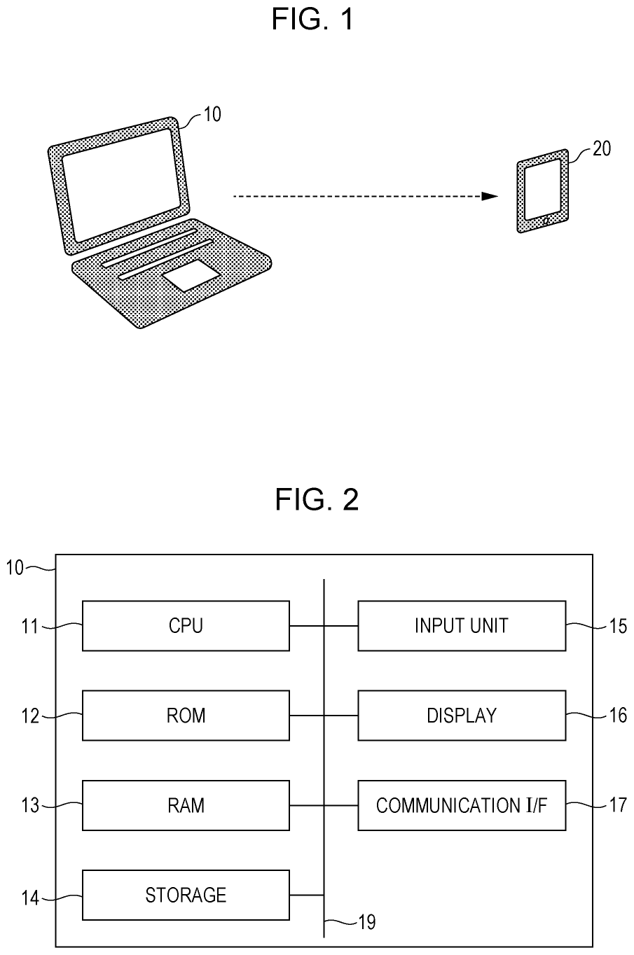

FIG. 1 is a diagram illustrating a schematic configuration of an information processing system according to the present exemplary embodiment. As illustrated in FIG. 1, the information processing system according to the present exemplary embodiment includes an information processing apparatus 10 and a mobile terminal 20. In the information processing system according to the present exemplary embodiment, it is assumed that the information processing apparatus 10 and the mobile terminal 20 are used by the same user.

In the present exemplary embodiment, the information processing apparatus 10 is an apparatus with a screen larger than that of the mobile terminal 20, such as a desktop or laptop personal computer or a tablet computer. In addition, the mobile terminal 20 is an apparatus with a screen smaller than that of the information processing apparatus 10, or with no screen, such as a smartphone, a tablet terminal, a smartwatch, or wireless earphones.

When the user is performing a certain task using the information processing apparatus 10, the user may want to output information to the mobile terminal 20, not to the information processing apparatus 10. For example, when the user is having a meeting using the information processing apparatus 10, the user may want to refer to confidential information; however, the user does not want the meeting partner to see the confidential information. In such a case, the user wants to output the confidential information using the mobile terminal 20 at his/her hand. In addition, for example, the scene is conceivable in which, when the user is attending a meeting using the information processing apparatus 10, the user wants to output the summary of a material to the mobile terminal 20.

The information processing apparatus 10 according to the present exemplary embodiment transmits information to the pre-registered mobile terminal 20 in response to a certain operation on a target from which information is requested to be output, which is executed on the information processing apparatus 10. By transmitting the information from the information processing apparatus 10 to the mobile terminal 20, the user may be able to easily refer to the information on the mobile terminal 20 at his/her hand.

FIG. 2 is a block diagram illustrating the hardware configuration of the information processing apparatus 10.

As illustrated in FIG. 2, the information processing apparatus 10 includes a central processing unit (CPU) 11, read-only memory (ROM) 12, random-access memory (RAM) 13, a storage 14, an input unit 15, a display 16, and a communication interface (I/F) 17. These configurations are connected via a bus 19 to be able to communicate with each other.

The CPU 11 is a central processing unit, and executes various programs and controls each unit. That is, the CPU 11 reads programs from the ROM 12 or the storage 14, and executes the programs using the RAM 13 as a work area. In accordance with the programs recorded in the ROM 12 or the storage 14, the CPU 11 controls the configurations described above and performs various types of arithmetic processing. In the present exemplary embodiment, an information transmission program for transmitting information to the mobile terminal 20 is stored in the ROM 12 or the storage 14.

The ROM 12 stores various programs and various data. As a work area, the RAM 13 temporarily stores a program or data. The storage 14 includes storage devices such as a hard disk drive (HDD), a solid state drive (SSD), flash memory, and/or the like, and stores various programs including an operating system, and various data.

The input unit 15 includes a pointing device such as a mouse, and a keyboard, and is used to input various types of information.

The display 16 is, for example, a liquid crystal display, and displays various types of information. The display 16 may adopt a touchscreen system to function as the input unit 15.

The communication interface 17 is an interface for communicating with another equipment such as the mobile terminal 20. For example, standards such as Ethernet (registered trademark), Fiber Distributed Data Interface (FDDI), Wi-Fi (registered trademark), and Institute of Electrical and Electronics Engineers (IEEE) 802.15 are used.

When executing the above-mentioned information transmission program, the information processing apparatus 10 implements various functions using the above-described hardware resources.

Next, the functional configuration of the information processing apparatus 10 will be described.

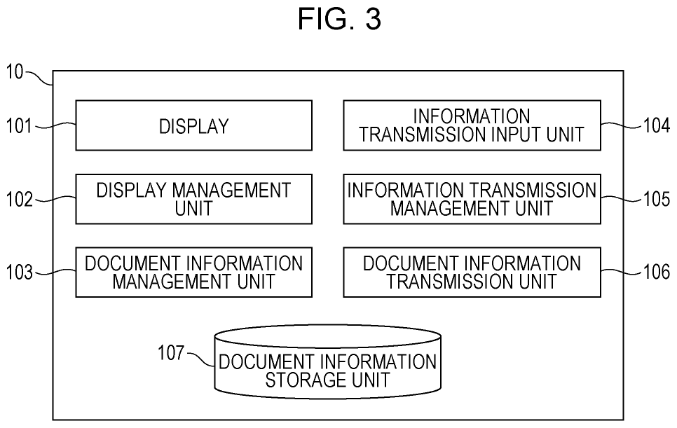

FIG. 3 is a block diagram illustrating an exemplary functional configuration of the information processing apparatus 10.

As illustrated in FIG. 3, the information processing apparatus 10 includes, as functional configurations, a display 101, a display management unit 102, a document information management unit 103, an information transmission input unit 104, an information transmission management unit 105, and a document information transmission unit 106. These functional configurations are implemented by reading and executing, by the CPU 11, the information transmission program stored in the ROM 12 or the storage 14. In addition, the information processing apparatus 10 includes a document information storage unit 107 that stores a document file. The document information storage unit 107 may be provided in, for example, the storage 14.

The display 101 displays various types of information. Displaying of information on the display 101 is performed by the display management unit 102.

The display management unit 102 manages displaying of information on the display 101. For example, the display management unit 102 manages, for a document file, content to be displayed on the display 101. Content to be displayed includes, for example, the title of the document file, the update date and time of the document file, and the thumbnail image of the document file. Content managed by the display management unit 102 is information obtained by the document information management unit 103.

The document information management unit 103 manages basic information for each document file stored by the document information storage unit 107. Basic information includes information such as the title of the document file and the creator of the document file. In addition, the document information management unit 103 manages, for each document file, information such as keywords representing features of the document, the summary of the document, and the thumbnail image of the document file. In addition, the document information management unit 103 manages content designated as confidential, out of content contained in the document file.

The information transmission input unit 104 receives an input of a method of transmitting information to the mobile terminal 20. For example, the information transmission input unit 104 receives an input of the transmission method, such as transmitting the information in text if the mobile terminal 20 is a smartphone, and transmitting the information in audio if the mobile terminal 20 is wireless earphones. Therefore, the method of transmitting information to the mobile terminal 20 depends on the type of the mobile terminal 20.

In response to a trigger which is a certain operation on document information representing a document file, on the basis of information from the information transmission input unit 104, the information transmission management unit 105 obtains information to be transmitted to the mobile terminal 20 from basic information managed by the document information management unit 103, and manages transmission to the document information transmission unit 106. Document information representing a document file includes, for example, the icon of the document file, the file name of the document file, and the like.

On the basis of a command from the information transmission input unit 104, the document information transmission unit 106 transmits the information transmitted from the information transmission management unit 105 to the pre-registered mobile terminal 20. Being in a pre-registered state refers to a state in which, for example, the information processing apparatus 10 has put the mobile terminal 20 in a pairing state.

For example, in the case where the information transmission input unit 104 has given a command to transmit information in audio because the pre-registered mobile terminal 20 is wireless earphones, the document information transmission unit 106 converts the information sent from the information transmission management unit 105 to audio data. The document information transmission unit 106 transmits the audio data after the conversion to the mobile terminal 20.

The document information transmission unit 106 may determine whether it is permitted to transmit content designated as confidential, out of content contained in a document file, to the mobile terminal 20. For example, the document information transmission unit 106 may determine, on the basis of the current position, whether it is permitted to transmit content designated as confidential to the mobile terminal 20. Specifically, if the current position obtained with a Global Positioning System (GPS) sensor or the like is at a pre-designated place, the document information transmission unit 106 may determine that it is permitted to transmit content designated as confidential to the mobile terminal 20.

In addition, the document information transmission unit 106 may determine, on the basis of a surrounding condition, whether it is permitted to transmit content designated as confidential to the mobile terminal 20. Specifically, an image of a surrounding condition may be captured, and, if it is determined that there are many people around, the document information transmission unit 106 may determine that it is not permitted to transmit content designated as confidential to the mobile terminal 20.

The document information transmission unit 106 may determine a target to be transmitted and/or a target to which information is transmitted according to the level of confidentiality set in advance to each document file. For example, if the confidentiality level is set to three levels, the document information transmission unit 106 may determine that it is permitted to transmit the content of a document file with the highest confidentiality level 1 only to wireless earphones, and it is permitted to transmit the content of a level-2 document file only to wireless earphones and a smartphone. The document information transmission unit 106 may determine that it is permitted to transmit the content of a level-3 document file to any of wireless earphones, a smartphone, and a tablet terminal.

At a time point at which a certain operation is performed by the user, the document information transmission unit 106 transmits, on the basis of a command from the information transmission input unit 104, information transmitted from the information transmission management unit 105 to the pre-registered mobile terminal 20. For example, when the user drags the icon or file name of a document file containing information requested by the user to be transmitted and drops the icon or the file name on the icon of an application that executes the information transmission program, the document information transmission unit 106 transmits the information to the mobile terminal 20. Alternatively, for example, by operating the icon or file name of a document file containing information requested by the user to be transmitted, a menu is displayed, and, in response to selection of a process of executing transmission of information from the menu, the document information transmission unit 106 transmits the information to the mobile terminal 20. Alternatively, for example, when the user clicks, with the mouse, the icon or file name of a document file containing information requested by the user to be transmitted, and, when a certain time elapses while the mouse cursor is being placed on the icon or the file name, the document information transmission unit 106 transmits the information to the mobile terminal 20. Needless to say, a certain operation performed by the user for transmitting the information to the mobile terminal 20 is not limited to the above-described operations.

Although FIG. 3 illustrates an example in which the information processing apparatus 10 includes therein the document information storage unit 107 which stores a document file, the present disclosure is not limited to this example. A document file serving as the basis of information to be transmitted to the mobile terminal 20 may be stored in an apparatus different from the information processing apparatus 10.

Next, the operation of the information processing apparatus 10 will be described.

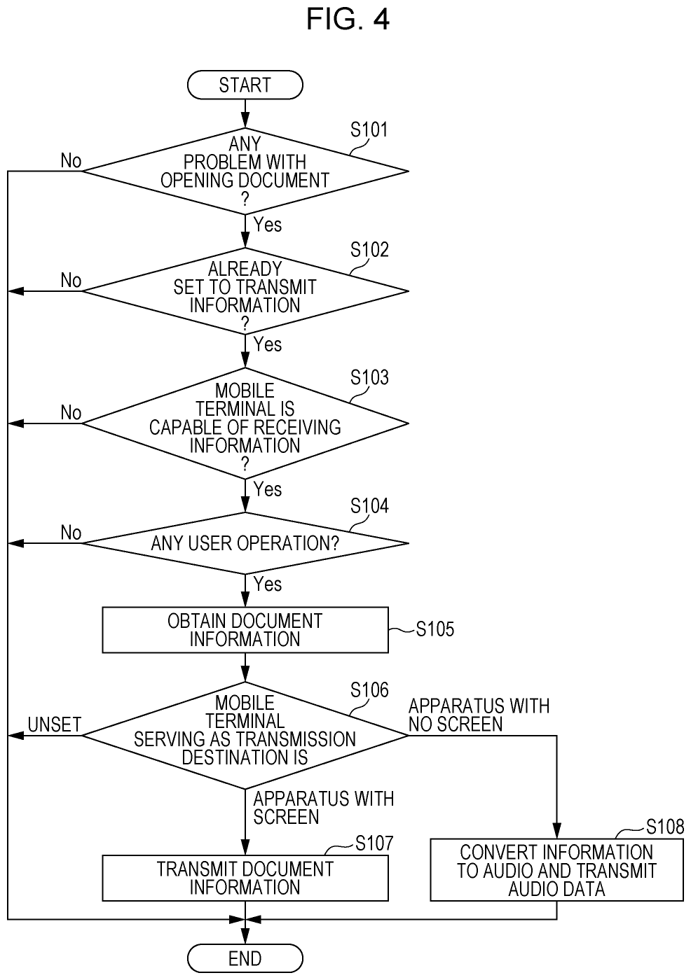

FIG. 4 is a flowchart illustrating the flow of an information transmission process performed by the information processing apparatus 10. The information transmission process is performed in response to reading, by the CPU 11, the information transmission program from the ROM 12 or the storage 14, expanding the program in the RAM 13, and executing the program.

At first, the CPU 11 determines whether there is a problem with opening a document file on the information processing apparatus 10 (step S101). Specifically, the CPU 11 may determine whether there is a problem with opening a document file on the information processing apparatus 10 depending on whether the current position of the information processing apparatus 10, obtained with a GPS sensor or the like, is at a pre-designated place. Alternatively, the CPU 11 may determine whether there is a problem with opening a document file on the information processing apparatus 10 depending on, as a result of capturing an image of a surrounding condition, whether there are people around. Note that, instead of a determination made by the CPU 11, the user of the information processing apparatus 10 may determine whether there is a problem with opening a document file on the information processing apparatus 10.

If the CPU 11 determines that currently there is no problem with opening a document file on the information processing apparatus 10 (NO in step S101), the CPU 11 ends the process. In contrast, if the CPU 11 determines that currently there is a problem with opening a document file on the information processing apparatus 10 (YES in S101), the CPU 11 then determines whether the user has set to transmit information to the pre-registered mobile terminal 20 (step S102).

If it is determined that the user has not set to transmit information to the mobile terminal 20 (NO in step S102), the CPU 11 ends the process. In contrast, if it is determined that the user has set to transmit information to the mobile terminal 20 (YES in step S102), the CPU 11 then determines whether the pre-registered mobile terminal 20 is currently capable of receiving information (step S103).

If it is determined that the pre-registered mobile terminal 20 is currently incapable of receiving information (NO in step S103), the CPU 11 ends the process. For example, when the power of the mobile terminal 20 is off or the mobile terminal 20 is not within a wirelessly communicable range from the information processing apparatus 10, the CPU 11 determines that the mobile terminal 20 is currently incapable of receiving information. In contrast, if it is determined that the mobile terminal 20 is currently capable of receiving information (YES in step S103), the CPU 11 then determines whether an operation has been performed on a document file serving as the target of information transmission (step S104). For example, the CPU 11 determines whether the user has performed an operation of selecting the title name or icon of a document file from which the user wants to obtain additional information. Alternatively, for example, the CPU 11 determines whether the user has dragged the icon or file name of a document file from which the user wants to obtain additional information and dropped the icon or the file name on the icon of an application for transmitting information.

If it is determined that no operation has been performed on a document file serving as the target of information transmission (NO in step S104), the CPU 11 ends the process. In contrast, if it is determined that an operation has been performed on a document file serving as the target of information transmission (YES in step S104), the CPU 11 then obtains information of a document to be transmitted to the mobile terminal 20 (step S105). For example, if it has been set to transmit confidential information to the mobile terminal 20, the CPU 11 obtains confidential information contained in the operated document file. Alternatively, for example, if it has been set to transmit a summary to the mobile terminal 20, the CPU 11 obtains the summary of the operated document file.

Next, the CPU 11 determines what kind of terminal the mobile terminal 20 to which information is to be transmitted is (step S106).

In the case where the mobile terminal 20 is an apparatus with a screen, such as a smartphone, the CPU 11 transmits information to the mobile terminal 20 (step S107). In the case where the mobile terminal 20 is an apparatus that is capable of outputting audio and that has no screen, such as wireless earphones, the CPU 11 converts information to audio and transmits the information as audio data to the mobile terminal 20 (step S108). In the case where the mobile terminal 20 is other types of unset apparatuses, the CPU 11 ends the process without transmitting information.

The information processing apparatus 10 according to the present exemplary embodiment executes the above-described serial process, thereby transmitting, to the pre-registered mobile terminal 20, information according to the type of the mobile terminal 20.

Next, exemplary use cases of the information processing apparatus 10 according to the present exemplary embodiment will be described.

At first, as the first use case, an example in which confidential information is transmitted from the information processing apparatus 10 to the mobile terminal 20 will be described. While the user is having a business negotiation with a client, the user may receive an unexpected question from the client. For example, the user may be requested by the client to discount a product. The user wants to refer to a document file containing discount rate information that may be set to the product; however, since the discount rate information is confidential information, the user does not want the client to see it. To this end, the user transmits the discount rate information from the information processing apparatus 10 to the mobile terminal 20, thereby becoming able to perform a discount negotiation without allowing the client to see the discount rate information.

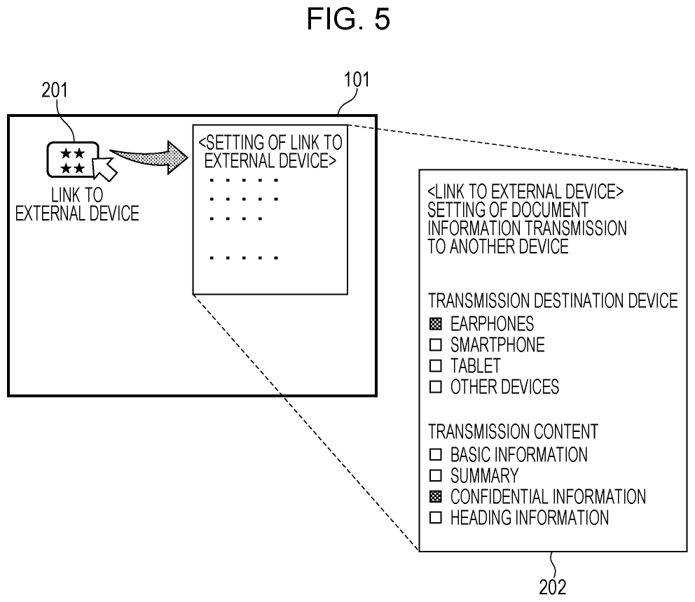

FIG. 5 is a diagram illustrating an exemplary user interface displayed on the display 101 of the information processing apparatus 10. Note that each user interface in the following description is displayed by the display management unit 102 on the display 101.

The user interface illustrated in FIG. 5 includes an icon 201. The icon 201 is an image for activating an application that executes a program for transmitting information to the mobile terminal 20.

A menu 202 is a menu displayed when the user places the mouse cursor on the icon 201 and performs a right click or the like. The menu 202 is a menu for allowing the user to set the setting of transmitting the content of a document file to the mobile terminal 20. In this use case, it has been set by the user that the mobile terminal 20 is wireless earphones, and the to-be-transmitted content is confidential information. Here, in response to selection of a device other than wireless earphones as the transmission destination device, the CPU 11 may limit the user interface so that confidential information will be unselectable as the to-be-transmitted content.

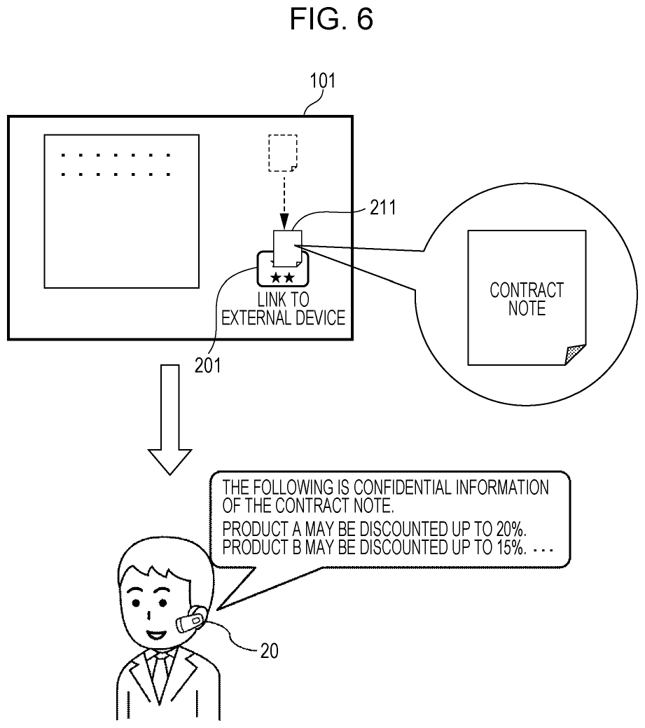

FIG. 6 is a diagram illustrating an exemplary user interface displayed on the display 101 of the information processing apparatus 10, and this is an example in the case where it has been set to transmit the content of a document file, as in FIG. 5.

It is assumed that the user drags an icon 211 of a document file containing information requested by the user to be transmitted and drops the icon 211 on the icon 201 of the application for transmitting information to the mobile terminal 20. The CPU 11 transmits the content of confidential information contained in the document file to the pre-registered mobile terminal 20. In this example, the mobile terminal 20 is wireless earphones. At this time, the CPU 11 converts the content of confidential information contained in the document file to audio and transmits it to the mobile terminal 20.

As described above, when the user sets the transmission of information contained in the document file and performs an operation on the information processing apparatus 10, the information processing apparatus 10 is allowed to transmit confidential information contained in the document file to the mobile terminal 20 which is wireless earphones. Since the user is able to listen to the confidential information using the mobile terminal 20 which is wireless earphones, the user may perform a discount negotiation on the spot without letting the client know the confidential information.

As the next use case, an example in which the summary of a document file is transmitted from the information processing apparatus 10 to the mobile terminal 20 will be described. Due to work style reforms in recent years, there are more and more opportunities to work outside the company. Depending on where or when the user works, the user may want to check only the summary without opening a document file that should not be shown to others. The user may open a document file on a smartphone that the user has; however, since the smartphone has a small screen, it takes time to find desired information from the document file. To this end, by transmitting the summary of a document file from the information processing apparatus 10 to the mobile terminal 20, the user may quickly find the desired document file as compared with the case where the summary is not transmitted.

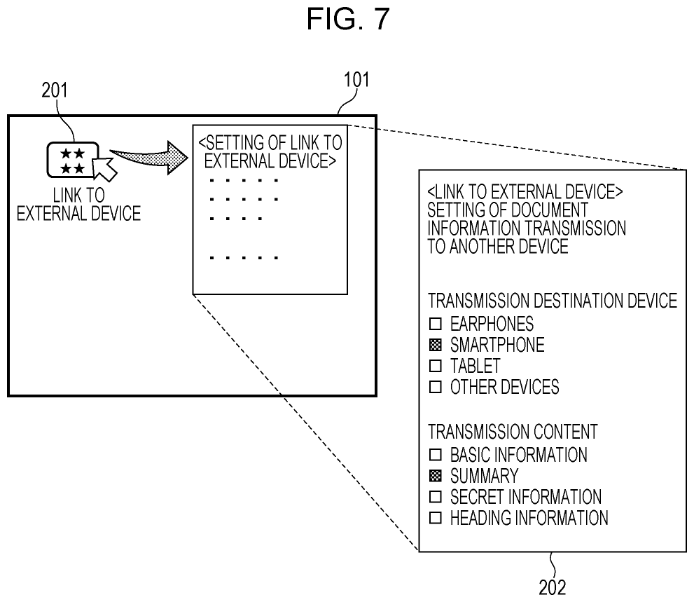

FIG. 7 is a diagram illustrating an exemplary user interface displayed on the display 101 of the information processing apparatus 10.

The user interface illustrated in FIG. 7 includes the icon 201. The icon 201 is an image for activating an application that executes a program for transmitting information to the mobile terminal 20.

The menu 202 is a menu displayed when the user places the mouse cursor on the icon 201 and performs a right click or the like. The menu 202 is a menu for allowing the user to set the setting of transmitting the content of a document file to the mobile terminal 20. In this use case, it has been set by the user that the mobile terminal 20 is a smartphone, and the to-be-transmitted content is a summary.

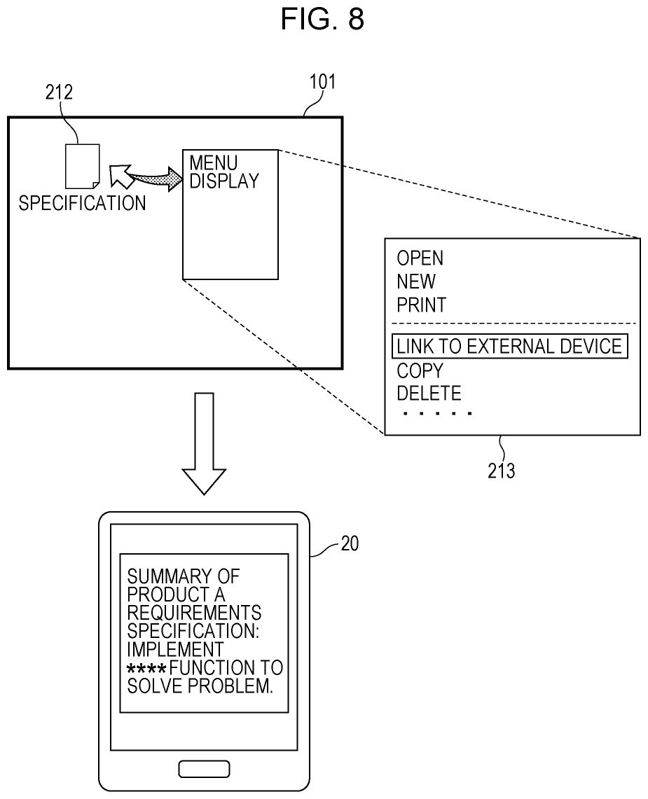

FIG. 8 is a diagram illustrating an exemplary user interface displayed on the display 101 of the information processing apparatus 10, and this is an example in the case where it has been set to transmit the content of a document file, as in FIG. 7.

It is assumed that the user opens a menu 213 by right-clicking an icon 212 of a document file containing information requested by the user to be transmitted to the mobile terminal 20. It is assumed that the document file is the specification of a product, and its content should not be shown to people outside the company. It is also assumed that the user selects “link to external device” from the menu 213. The CPU 11 transmits the content of a summary contained in the document file to the pre-registered mobile terminal 20. In this example, the mobile terminal 20 is a smartphone.

As described above, when the user sets the transmission of information contained in the document file and performs an operation on the information processing apparatus 10, the information processing apparatus 10 is allowed to transmit the summary of the document file to the mobile terminal 20 which is a smartphone. Because the user may look at the summary of the document file on the mobile terminal 20 which is a smartphone, the user may grasp the content of the document file without opening the content of the document file on the information processing apparatus 10. In short, the user is able to refer to the summary of the document file on the mobile terminal 20 while preventing the risk of information leakage due to peeping into the screen of the information processing apparatus 10.

The use cases where the information processing apparatus 10 is used are not limited to those described above. For example, in the case where the user brings the information processing apparatus 10 to attend a meeting in a company, sometimes the user wants to refer to a meeting material not on the information processing apparatus 10 but on the mobile terminal 20 at his/her hand. In that case, the user executes, on the information processing apparatus 10, an operation on a document file from which the user wants to obtain information, which then allows the user to refer to the information on the mobile terminal 20.

Note that the information transmission process executed by the CPU by reading software (programs) in the above-described exemplary embodiment may be executed by various processors other than the CPU. In this case, examples of the processor include a programmable logic device (PLD) whose circuit configuration is changeable after manufacturing, such as a field-programmable gate array (FPGA), and a dedicated electric circuit that is a processor with a circuit configuration designed specifically for executing a specific process, such as an application specific integrated circuit (ASIC). In addition, the information transmission process may be executed by one of these various processors, or by a combination of two or more processors of the same type or different types (such as a plurality of FPGAs, a combination of a CPU and an FPGA, and so forth). The hardware structure of these various processors is, more specifically, an electric circuit combining circuit elements such as semiconductor elements.

Although a mode in which a program of the information transmission process is stored (installed) in the ROM or the storage in advance has been described in the above-described exemplary embodiment, the mode is not limited to the above mode. The mode may be such that the program is provided by being recorded in a non-temporary recording medium, such as a compact disc read-only memory (CD-ROM), a digital versatile disc read-only memory (DVD-ROM), or a Universal Serial Bus (USB) flash drive. Alternatively, the mode may be such that the program is downloaded from an external apparatus via a network.

The operation of the processor in the above-described exemplary embodiment may be implemented not only by one processor, but by plural processors in collaboration which are located physically apart from each other but may work cooperatively. The order of operations of the processor is not limited to one described in the exemplary embodiment above, and may be changed as appropriate.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to
in response to a certain operation on document information representing a document file presented on a screen, transmit content of the document file to another apparatus registered in advance, with a screen smaller than the screen of the information processing apparatus or with no screen, based on a type of the another apparatus.

2. The information processing apparatus according to claim 1, wherein the processor is configured to transmit content designated as confidential, out of content contained in the document file, to the another apparatus.

3. The information processing apparatus according to claim 2, wherein the processor is configured to determine, based on a current position, whether it is permitted to transmit content designated as confidential to the another apparatus.

4. The information processing apparatus according to claim 2, wherein the processor is configured to determine, based on a surrounding condition, whether it is permitted to transmit content designated as confidential to the another apparatus.

5. The information processing apparatus according to claim 1, wherein the processor is configured to transmit content of the document file as audio data to the another apparatus in a case where the another apparatus is an apparatus with no screen.

6. The information processing apparatus according to claim 5, wherein the processor is configured to transmit content of the document file, which is designated as confidential, as audio data to the another apparatus.

7. The information processing apparatus according to claim 1, wherein the processor is configured to transmit content of the document file to the another apparatus based on content of a pre-set transmission setting.

8. The information processing apparatus according to claim 7, wherein the transmission setting is set for each of the type of the another apparatus and content to be transmitted to the another apparatus.

9. The information processing apparatus according to claim 1, wherein the document information is an icon or a file name of the document file.

10. The information processing apparatus according to claim 9, wherein the processor is configured to transmit content of the document file to the another apparatus at a time point at which a certain time elapses since selection of the icon or the file name as the certain operation.

11. A non-transitory computer readable medium storing a computer program causing an information processing apparatus to execute a process, the process comprising:
in response to a certain operation on document information representing a document file presented on a screen, transmitting content of the document file to another apparatus registered in advance, with a screen smaller than that of the information processing apparatus or with no screen, based on a type of the another apparatus.

12. An information processing apparatus comprising:
means for
in response to a certain operation on document information representing a document file presented on a screen, transmitting content of the document file to another apparatus registered in advance, with a screen smaller than that of the information processing apparatus or with no screen, based on a type of the another apparatus.
